(19) United States
(12) Patent Application Publication
(10) Pub. No.: US 2017/0108056 A1
(43) Pub. Date: Apr. 20, 2017

(54) MODULAR ACTUATOR CONCEPT FOR A CLUTCH ACTUATOR

(71) Applicant: Schaeffler Technologies AG & Co. KG, Herzogenaurach (DE)

(72) Inventors: Peter Greb, Ottersweier (DE); Lászlo Mán, Ottersweier-Unzhurst (DE); Lars Schumann, Buehl (DE); Alexander Dreher, Sinzheim (DE)

(21) Appl. No.: 15/129,471

(22) PCT Filed: Mar. 13, 2015
(86) PCT No.: PCT/DE2015/200156

§ 371 Date: Sep. 27, 2016

(30) Foreign Application Priority Data
Apr. 2, 2014 (DE) 10 2014 206 300.0

(51) Int. Cl. F16D 23/12; F16D 25/08; F16D 28/00

(52) U.S. Cl. CPC F16D 23/12; F16D 28/00; F16D 25/08

(57) ABSTRACT

A modular concept is proposed for an actuator, in particular a clutch and/or transmission actuator. An electric motor is provided with a universal flange. Through this flange it is possible to connect an electrohydraulic or electromechanical actuating link. A clutch and/or a transmission setting device can then be actuated by means of the resulting actuator. In particular, for use for an electrohydraulic actuator, the motor housing may also have a receptacle for a pressure sensor. This receptacle may already be closed, or may be closed for the connection to a mechanics module.

The present application is the United States National Stage Application pursuant to 35 U.S.C. §371 of International Patent Application No. PCT/DE2015/200156, filed on Mar. 13, 2015, and claims priority to German Patent Application No. DE 10 2014 206 300.0 of Apr. 2, 2014, which applications are incorporated by reference in their entireties.

### FIELD

The invention relates to an actuator for a clutch an/or transmission having an electric motor, more particularly, an electric motor having a universal flange to allow for an electrohydraulic or electromechanical actuating link.

### BACKGROUND

Electromechanical and electrohydraulic clutch actuating systems are known, for example for clutch by wire (CBW) applications.

Actuators of the respective different type (electromechanical/electrohydraulic) are used specifically for this, which have in each case, drive systems adapted to the actuator. This requires appropriate effort for development but also in other areas, such as for example, design, production, parts support, parts management, or warehousing.

### SUMMARY

To reduce at least part of this effort, it is proposed to use one and the same electric motor (including electronics) for both electromechanical and electrohydraulic clutch actuation. Accordingly, this electric motor is intended as a module for at least the two enumerated actuator variants.

For this purpose, use can be made of the fact that the main energy requirement to actuate a clutch depends almost exclusively on the clutch being actuated, and only to a very small extent on the type of actuation/transmission link.

This motor module includes a linear actuator having a universal flange to accommodate a mechanics module and a hydraulics module. Both modules may optionally be flange-mounted, thus completing either an electromechanical or an electrohydraulic actuator.

If applicable, a universal attaching flange may be provided on the modules, on which a ready-made assembly adapter may be flange-mounted for attachment in the customer's manufacturing hall. Thus, even the (relatively complex) module housing may be identical across all customer projects.

For the hydraulics module, circuit board contacting may possibly be necessary for a pressure sensor. When the motor module is used for an electromechanical actuator, the opening provided for that purpose in the housing is simply closed.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is an electrohydraulic actuator in modular construction, with motor;

FIG. 2 is an electromechanical actuator in modular construction, with motor;

FIG. 3 is a top view of the electrohydraulic actuator according to FIG. 1;

FIG. 4 is a side view of the electromechanical actuator according to FIG. 2;

FIG. 5 is a side view of the motor module;

FIG. 6 is a top view of the motor module;

FIG. 7 is a top view of the hydraulics module according to FIG. 1;

FIG. 8 is a side view of the hydraulics module according to FIG. 1; and,

FIG. 9 is a side view of the mechanics module according to FIG. 2.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

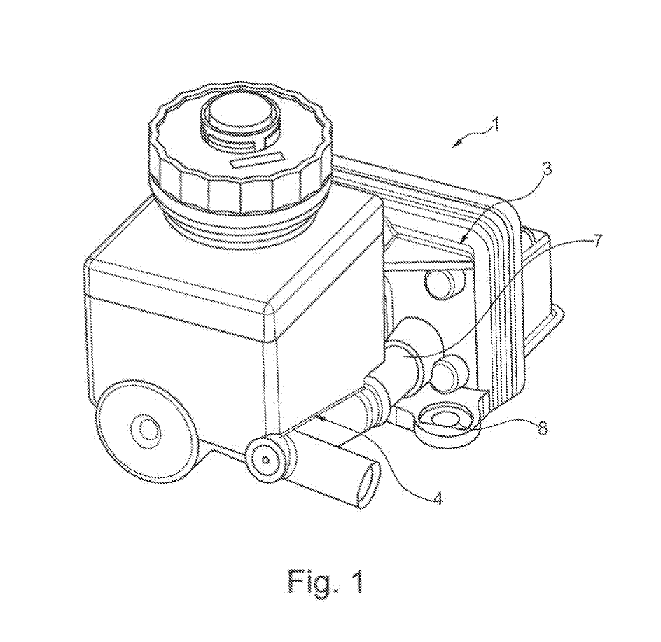

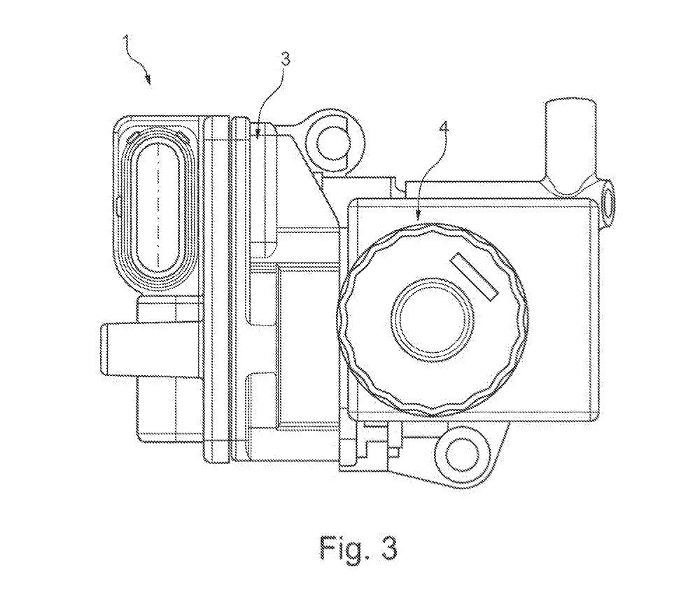

FIGS. 1 and 3 show various views of hydraulic actuator 1. Hydraulic actuator 1 always includes at least motor module 3 and hydraulics module 4.

Hydraulic actuator 1 is also referred to as an electrohydraulic actuator, and may address a slave cylinder of a clutch via a hydraulic link to actuate it. This may be, in particular, a sub-clutch of a dual clutch.

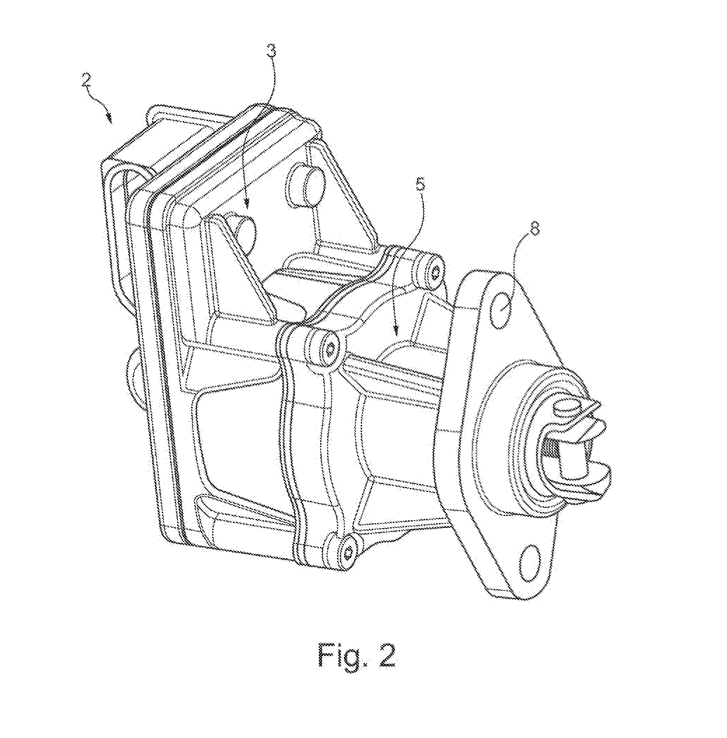

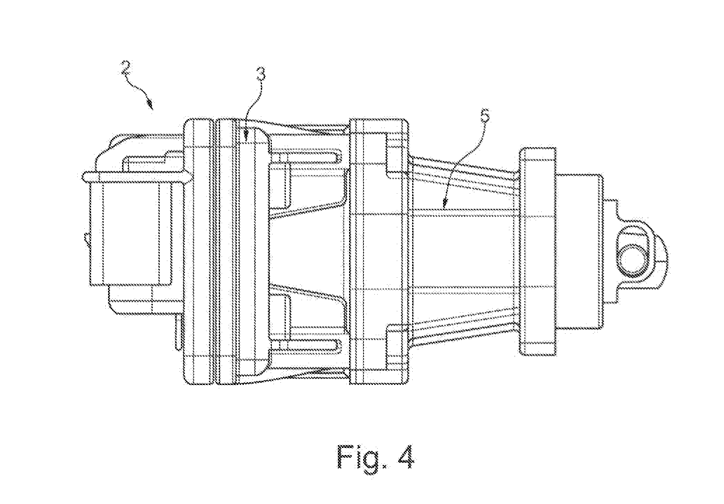

FIGS. 2 and 4 show mechanical actuator 2, which is also referred to as an electromechanical actuator. The latter includes at least motor module 3 and mechanics module 5. Motor module 3 is motor module 3 which is identical to the motor module of hydraulic actuator 1, and has therefore also been identified using the same reference label.

Mechanical actuator 2 may be employed either as a master cylinder or directly as a slave cylinder in an actuating link for a clutch, in particular a sub-clutch of a dual clutch. Here, it may be used, for example, in a clutch by wire device, and convert an electronic signal into an actuation of a clutch.

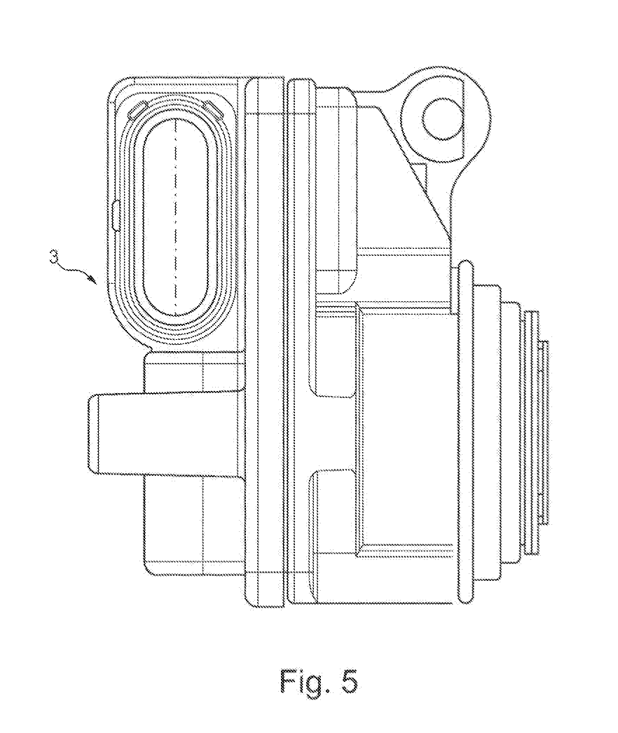

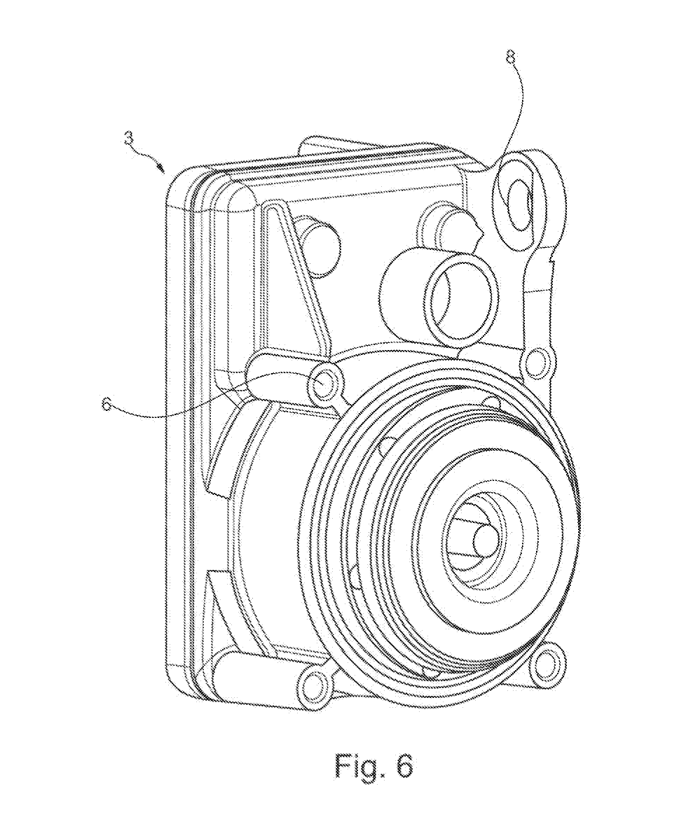

FIGS. 5 and 6 show motor module 3 without additional connected modules 2 or 4. It is possible to recognize housing flange 6 for connecting motor module 3 optionally to hydraulics module 4 or mechanics module 5, and housing flange 8 for installing motor module 3 or assembled hydraulic actuator 1 or mechanical actuator 2 in the transmission housing or on some other component of a motor vehicle. Also visible in FIG. 5 is the electronics connection of motor module 3.

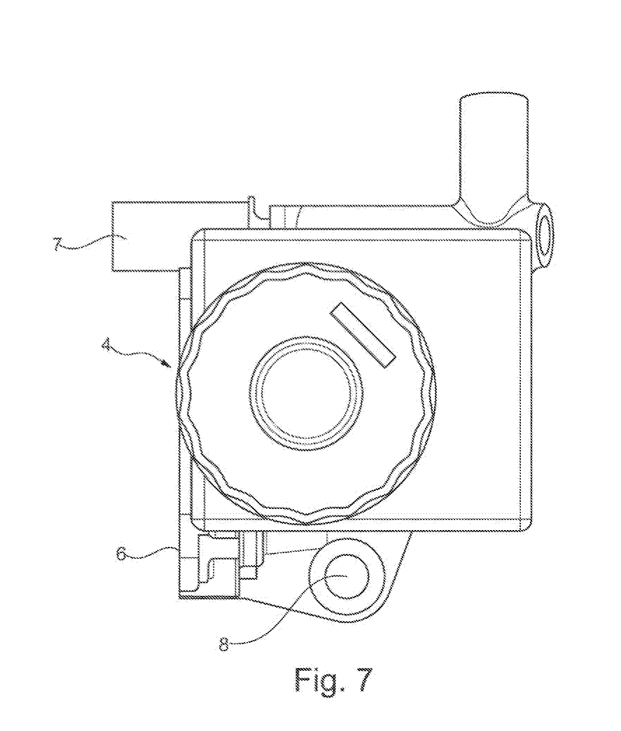

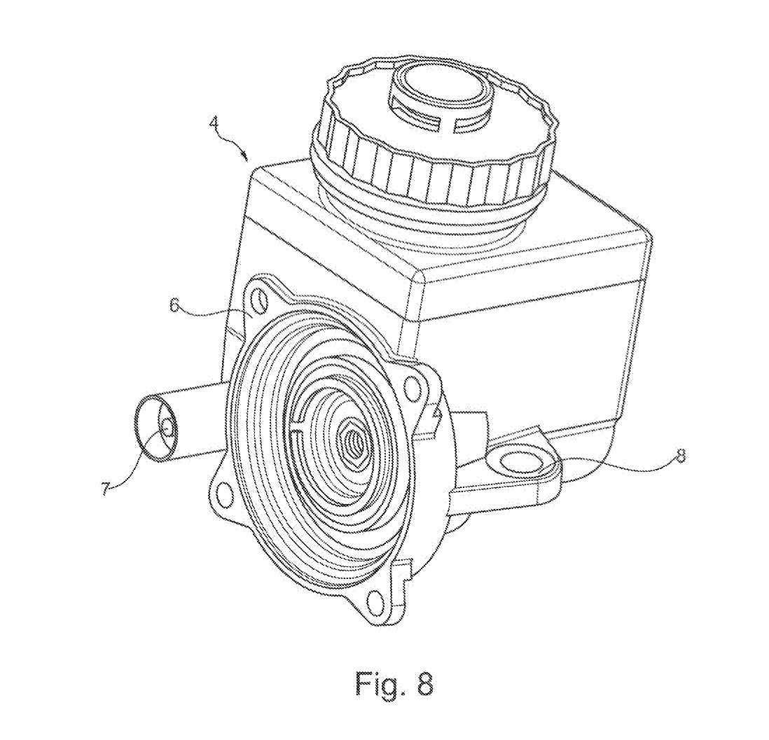

FIGS. 7 and 8 show various views of hydraulics module 4, without it being attached to the motor module. Also recognizable besides motor flange 6 for fastening motor module 3 is yet another housing flange 8, with which the assembled hydraulic actuator 1 may be attached to a housing/transmission housing, as well as pressure sensor 7 with which the pressure in the hydraulic link may be measured.

As can be seen in FIG. 1, pressure sensor 7 is accommodated in an appropriate receptacle of motor module 3. This receptacle is closable when motor module 3 is connected to mechanics module 5.

Motor module 3 also has connections for pressure sensor 7, so that a connection to the circuit board of motor module 3 is established when pressure sensor 7 is plugged in. This makes it possible to read pressure sensor 7 and to drive the motor of motor module 3.

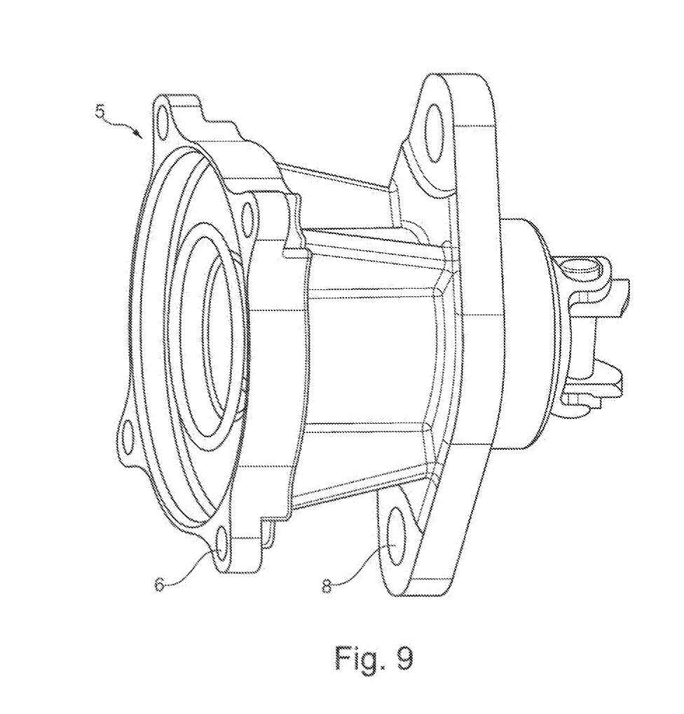

FIG. 9 shows mechanics module 5, which has motor flange 6 for connecting to motor module 3 and an additional housing flange 8 for connecting to a housing.

A modular concept for an actuator for clutch actuation is achieved in the manner described above. The actuator includes a motor module, which includes an electric motor and if necessary a shaft, if necessary also a gear unit. By means of motor flange 6 of motor module 3, the latter may optionally be connected to hydraulics module 4 or mechanics module 5, which accordingly also have motor flange 6 for this purpose.

Additional contact points may be provided by means of shafts and/or gear units on motor module 3 and/or on hydraulics or mechanics module 4, 5.

Motor module 3 is therefore identical for both actuator types, that is, hydraulic actuator 1 or mechanical actuator 2. It also has an opening to accommodate pressure sensor 7 or additional or other sensors, which is closed if not needed.

In this way, different actuator types can be realized cost-effectively and quickly in a simple way.

So, a modular concept is proposed for an actuator, in particular a clutch and/or transmission actuator. An electric motor is provided for this purpose, by means of motor module 3 having a universal flange in the form of motor flange 6. It is then possible by means of flange 6 to connect an electrohydraulic or electromechanical actuating link in the form of hydraulics module 4 or mechanics module 5. A clutch and/or a transmission setting device can then be actuated by means of the resulting actuator.

In particular for use for electrohydraulic actuator 1, the motor housing, that is, motor module 3, may also have a receptacle for pressure sensor 7. This receptacle may already be closed, or may be closed for the connection to an electromechanical actuating part, i.e., a mechanics module.

The modular concept is usable for an HZA or the like.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE LABELS

1 hydraulic actuator
2 mechanical actuator
3 motor module
4 hydraulics module
5 mechanics module
6 motor flange
7 pressure sensor
8 housing flange

What is claimed is:

1-8. (canceled)

9. An actuator for clutch actuation, comprising:
a motor module; and,
an actuating module.

10. An actuator as recited in claim 9, wherein the motor module is optionally connectible to a hydraulics module or a mechanics module.

11. An actuator as recited in claim 9, wherein the motor module and/or the actuating module comprises a motor flange.

12. An actuator as recited in claim 9, wherein the motor module and/or the actuating module comprises at least one housing flange for connecting to a housing.

13. An actuator as recited in claim 9, wherein the motor module has at least one closable opening to accommodate a sensor element, preferably a pressure sensor.

14. An actuator as recited in claim 13, wherein:
the closable opening provides an electrical connection;
the motor module comprises at least one circuit element; and, the electrical connection is able to produce a connection between the sensor element and the circuit element.

15. An actuator as recited in claim 14, wherein the at least one circuit element is a circuit board.

16. A drivetrain of a motor vehicle, comprising:
at least one clutch unit including at least one clutch; and,
an actuator as recited in claim 9, wherein the actuator actuates the at least one clutch.

17. A method for providing an actuator for actuating a clutch, wherein a motor module, optionally using a hydraulics module or a mechanics module, is connected by means of a motor flange optionally to a hydraulic actuator or a mechanical actuator.
